(19) United States
(12) Patent Application Publication
(10) Pub. No.: US 2020/0301631 A1
(43) Pub. Date: Sep. 24, 2020

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Jo SUDA, Kanagawa (JP)

(73) Assignee: FUJI XEROX CO., LTD., Tokyo (JP)

(21) Appl. No.: 16/530,217

(22) Filed: Aug. 2, 2019

(30) Foreign Application Priority Data
Mar. 20, 2019 (JP) 2019-053405

(51) Int. Cl. G06F 3/12; H04N 1/32; H04N 1/00

(52) U.S. Cl. CPC G06F 3/1232; H04N 1/00029; G06F 3/1203; H04N 1/32101

(57) ABSTRACT

An information processing system includes a specifying unit and a display controller. When an abnormality occurs in a first unit constituting a first device connected to a management apparatus, the specifying unit specifies a second unit, corresponding to the abnormal first unit, in a second device connected to the management apparatus. The display controller displays information on the specified second device.

### CROSS-REFERENCE TO RELATED APPLICATIONS

This application is based on and claims priority under 35 USC 119 from Japanese Patent Application No. 2019-053405 filed Mar. 20, 2019.

### BACKGROUND

### (i) Technical Field

The present disclosure relates to an information processing system, an information processing apparatus and a non-transitory computer readable medium.

### (ii) Related Art

In recent years, there has been proposed an image encoder which implements high-efficiency coding of an image signal while maintaining high image quality without using a complicated circuit (see, for example, JP-A 7-143493).

The image encoder described in JP-A 7-143493 includes: a sampling unit that subsamples an input digital image signal; a first encoding mode that compression codes the image signal with a difference signal obtained by subtracting a prediction value from the subsampled image signal; and an encoder that selectively switches and codes a second encoding mode which compression codes the image signal without using the difference signal.

### SUMMARY

Aspects of non-limiting embodiments of the present disclosure relate to providing an information processing system, an information processing apparatus and a non-transitory computer readable medium that are capable of enabling a function related to a specific part even when an abnormality occurs in the specific part among parts constituting a device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a specifying unit configured to, when an abnormality occurs in a first unit constituting a first device connected to a management apparatus, specify a second unit, corresponding to the abnormal first unit, in a second device connected to the management apparatus; and a display controller configured to display information on the specified second device.

### BRIEF DESCRIPTION OF THE DRAWINGS

Exemplary embodiment(s) of the present disclosure will be described in detail based on the following figures, wherein:

FIG. 1 is a view illustrating an example of the configuration of an image forming system according to an exemplary embodiment of the present disclosure;

FIG. 2 is a block diagram illustrating an example of a control system of a server apparatus illustrated in FIG. 1;

FIG. 3 is a block diagram illustrating an example of a control system of the image forming apparatus illustrated in FIG. 1;

FIG. 4 is a view illustrating an example of a user management table;

FIG. 5 is a view illustrating an example of a contract information table;

FIG. 6 is a view illustrating an example of a device parts information table;

FIG. 7 is a view illustrating an example of an area information table;

FIG. 8 is a view illustrating an example of a machine master;

FIG. 9 is a view illustrating an example of a unit exchange determination master;

FIG. 10 is a view illustrating an example of a machine function master;

FIG. 11 is a view illustrating an example of a multifunction device management portal list screen;

FIG. 12 is a view illustrating an example of a multifunction device management parts state screen;

FIG. 13 is a view illustrating an example of a multifunction device management portal substitution parts details list screen;

FIG. 14 is a view illustrating an example of an alert e-mail;

FIG. 15 is a flowchart illustrating an example of the operation of the image forming apparatus illustrated in FIG. 1;

FIG. 16 is a flowchart illustrating an example of the operation of the server apparatus illustrated in FIG. 1;

FIG. 17 is a flowchart illustrating an example of an administrator's operation; and

FIG. 18 is a flowchart illustrating an example of the details check operation illustrated in FIG. 17.

### DETAILED DESCRIPTION

Hereinafter, exemplary embodiments of the present disclosure will be described with reference to the drawings. In each of the drawings, elements having substantially the same functions are denoted by the same reference numerals, and explanation thereof will not be repeated. Hereinafter, an image forming system will be described as an example of an information processing system. It should be noted that the information processing system is not limited to the image forming system. Further, a server apparatus or an image forming apparatus will be described as an example of the information processing apparatus. It should be noted that the information processing apparatus is not limited to the server apparatus or the image forming apparatus.

### Exemplary Embodiments

### [Configuration of Image Forming System]

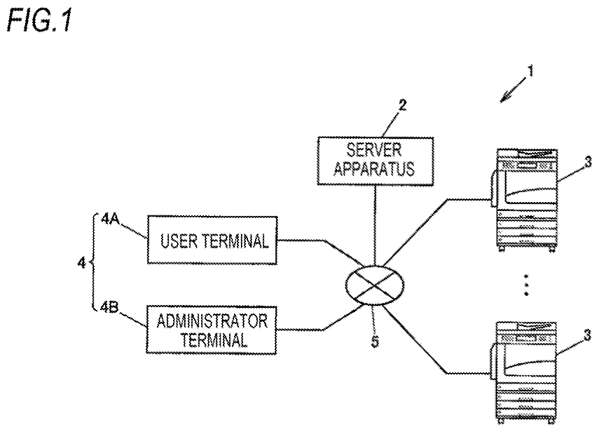

FIG. 1 is a view illustrating an example of the configuration of an image forming system 1 according to an exemplary embodiment of the present disclosure. The image forming system 1 includes a server apparatus 2, an image forming apparatus 3 and a terminal apparatus 4. The server apparatus 2, the image forming apparatus 3 and the terminal apparatus 4 are interconnected via a network 5. The image forming system 1 is an example of an information processing system. The server apparatus 2 is an example of a management apparatus and an information processing apparatus. The image forming apparatus 3 is an example of an information processing apparatus. When the image forming apparatus 3 is treated as an object of management by the server apparatus 2, the image forming apparatus 3 may be simply referred to as a “device”. The device is an example of a device.

The terminal apparatus 4 includes a user terminal 4A used by a user and an administrator terminal 4B used by an administrator. Here, the term “user” includes a general user who uses various functions of the image forming apparatus 3, and a specific user who has more authorities than the general user (so-called administrator on the use side). The term “administrator” includes a provider of the image forming system 1 and a person responsible for repair and maintenance of the image forming system 1.

### (Server Apparatus 2)

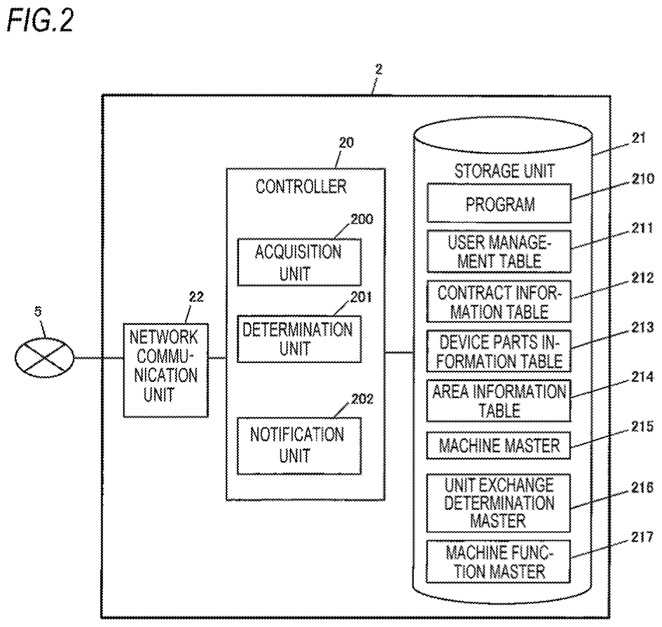

FIG. 2 is a block diagram illustrating an example of a control system of the server apparatus 2. The server apparatus 2 is, for example, a DFE (Digital Front End) apparatus. The server apparatus 2 is also referred to as a “multifunction device management portal”.

As illustrated in FIG. 2, the server apparatus 2 includes a controller 20 that controls each unit, a storage unit 21 that stores various data, and a network communication unit 22 that communicates between the image forming apparatus 3 and the terminal apparatus 4 via the network 5.

The controller 20 is implemented by a CPU (Central Processing Unit), an interface and the like. The CPU operates according to a program 210 stored in the storage unit 21 so as to function as an acquisition unit 200, a determination unit 201, a notification unit 202 and the like. The acquisition unit 200 and the determination unit 201 are examples of a specifying unit. The details of the respective units 200 to 202 will be described later.

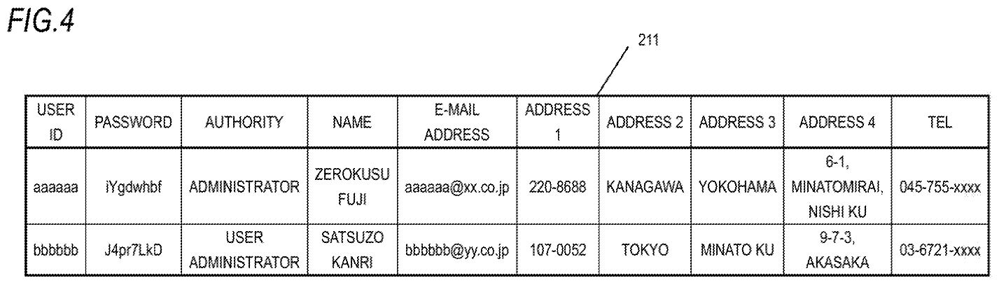

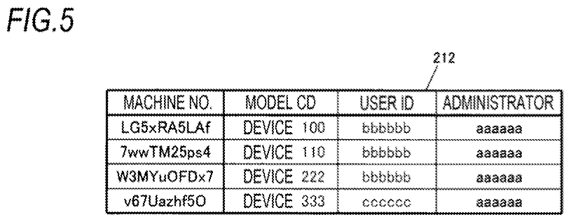

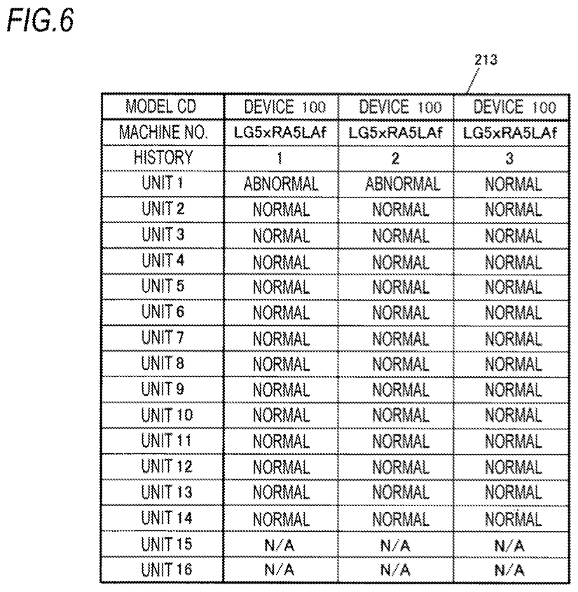

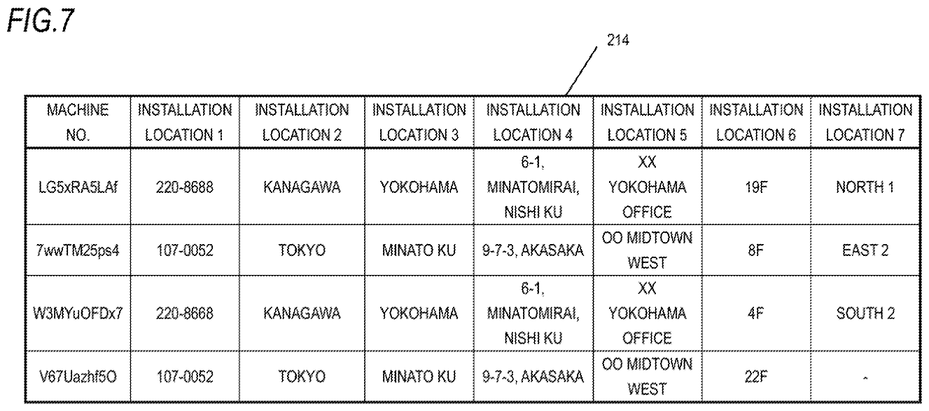

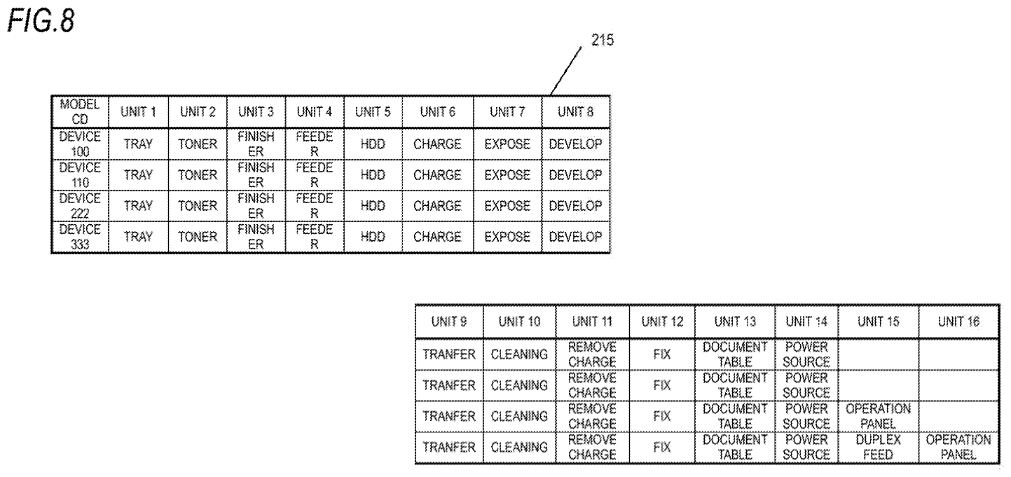

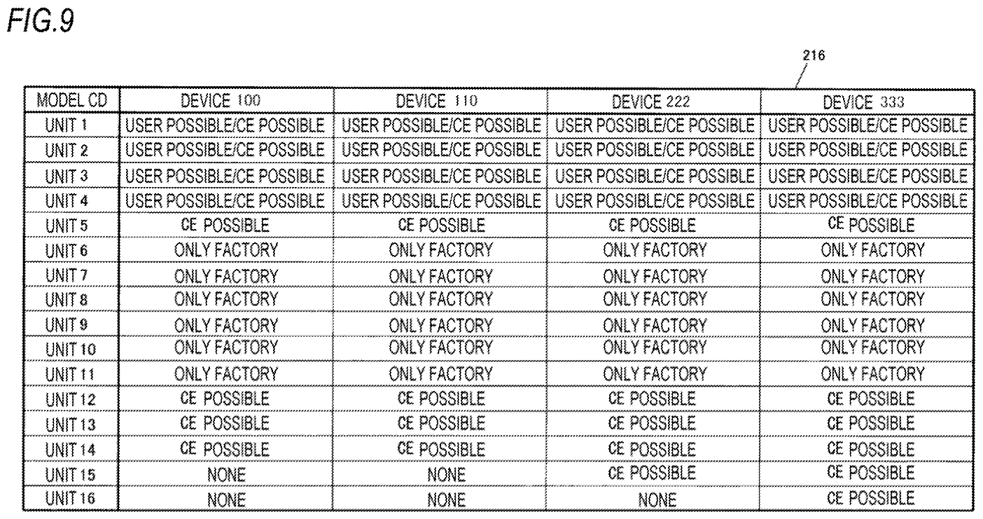

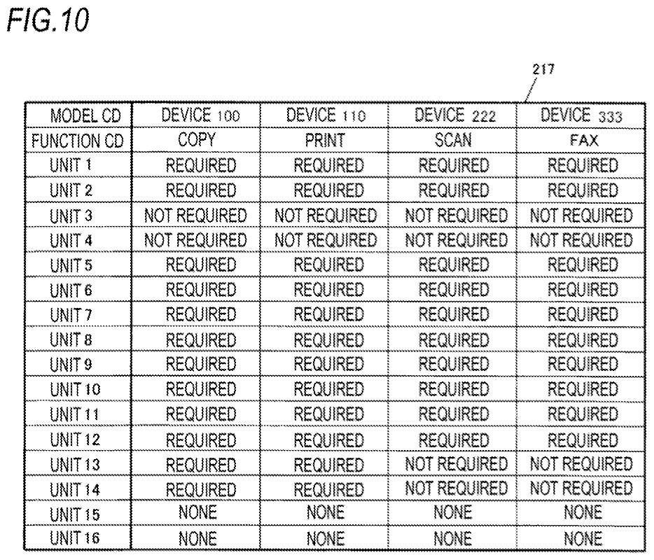

The storage unit 21 is implemented by a ROM (Read Only Memory), a RAM (Random Access Memory), a hard disk or the like, and stores a program 210 and various data such as a user management table 211 (see FIG. 4), a contract information table 212 (see FIG. 5), a device parts information table 213 (see FIG. 6), an area information table 214 (see FIG. 7), a machine master 215 (see FIG. 8), a unit exchange determination master 216 (see FIG. 9), and a machine function master 217 (see FIG. 10). The details of the respective tables and masters will be described later.

The network communication unit 22 is implemented by an NIC (Network Interface Card) or the like, and exchanges signals with the image forming apparatus 3 and the terminal apparatus 4 via the network 5.

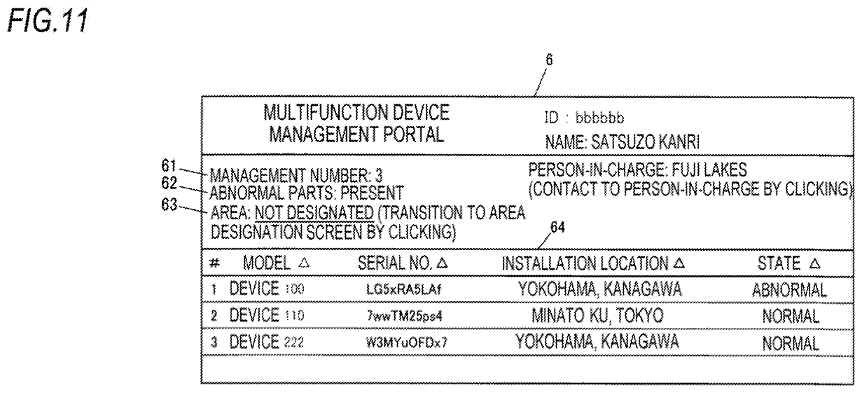

The acquisition unit 200 acquires various types of stored information from the storage unit 21. In addition, the acquisition unit 200 displays various screens on which the acquired information is displayed (see FIGS. 11 to 14, which will be described later) on a display of the display unit of the administrator terminal 4B (not illustrated).

The determination unit 201 refers to the unit exchange determination master 216 to determine whether a part or a function in which an abnormality occurs may be exchanged by the work of the user. The term “abnormality” refers to a case where a thing does not operate normally. The term “abnormality” also includes, for example, (i) a case where a part or the whole of a thing is damaged to cause a trouble in the normal start, and (ii) a case where a thing does not operate at all (for example, the thing fails). The term “function” mainly refers to one implemented by a hardware. The term “function” may be collectively referred as a “unit” or a “part”.

When there is a unit having an abnormality (hereinafter, also simply referred to as an “abnormal unit”), the notification unit 202 refers to the device parts information table 213 to notify the administrator that there is an abnormal unit. The abnormal unit is an example of a first unit. A device including the abnormal unit is an example of a first device.

### (Image Forming Apparatus 3)

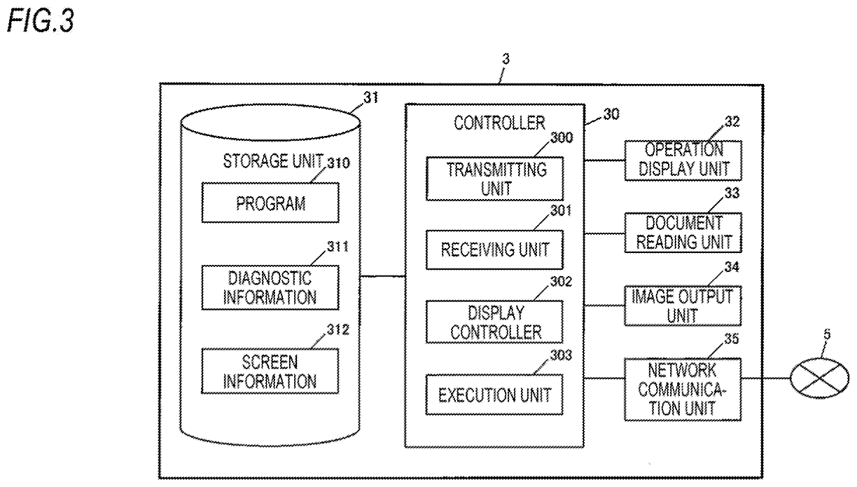

FIG. 3 is a block diagram illustrating an example of a control system of the image forming apparatus 3. The image forming apparatus 3 is, for example, a multifunction device having plural functions such as a scan function, a printer function, a copy function, a facsimile function, and an electronic mail function. The multifunction device is an example of the image forming apparatus 3, and the image forming apparatus 3 is not limited to the multifunction device.

The image forming apparatus 3 includes a controller 30 that controls each unit, a storage unit 31 that stores various data, an operation display unit 32 that inputs and displays information, a document reading unit 33 that reads a document image from a document, an image output unit 34 that prints out an image, and a network communication unit 35 that communicates with the image forming apparatus 3 and the terminal apparatus 4 via the network 5.

The controller 30 is implemented by a CPU, an interface and the like. The CPU operates according to a program 310 stored in the storage unit 31 so as to function as a transmitting unit 300, a receiving unit 301, a display controller 302, an execution unit 303 and the like. The details of the respective units 300 to 303 will be described later.

The storage unit 31 is implemented by a ROM, a RAM, a hard disk or the like, and stores various data such as the program 310, diagnostic information 311 and screen information 312. The diagnostic information 311 is data that stores the result of diagnosing the state of a device in advance. The diagnosis is performed by, for example, the controller 30. The screen information 312 will be described later.

The operation display unit 32 is, for example, a touch panel display, and has a configuration in which a touch panel is superimposed on a display such as a liquid crystal display.

The document reading unit 33 reads a document image from a document. The document reading unit 33 includes an automatic document feeder (not illustrated) provided on a document table (not illustrated), and a scanner (not illustrated). The document reading unit 33 optically reads a document image from a document placed on the document table or a document fed by the automatic document feeder.

The image output unit 34 prints out a color image or a black and white image on a recording medium such as a sheet by, for example, an electrophotographic system, an inkjet system or the like.

The network communication unit 35 exchanges signals with the server apparatus 2 and the terminal apparatus 4 via the network 5.

The transmitting unit 300 transmits various types of information to the server apparatus 2 and the terminal apparatus 4. The receiving unit 301 receives various types of information transmitted from the server apparatus 2 and the terminal apparatus 4. The display controller 302 performs a control to display various types of information on the display (not illustrated) of the operation display unit 32. The execution unit 303 controls the document reading unit 33, the image output unit 34 and the like to execute the respective processes thereof.

### (Table Configuration)

Next, the configurations of various tables used in the image forming system 1 will be described. FIG. 4 is a view illustrating an example of the user management table 211. The user management table 211 manages information on users who may log in to the server apparatus 2. As illustrated in FIG. 4, the user management table 211 records information such as a “user ID”, a “password”, an “authorization”, a “name”, an “e-mail address”, an “address”, and a “phone number (TEL)”.

FIG. 5 is a view illustrating an example of the contract information table 212. The contract information table 212 manages the model of the image forming apparatus 3 with which a user has made a contract. As illustrated in FIG. 5, the contract information table 212 records information such as, for example, a “machine No.”, a “model CD”, a “user ID”, and “administrator”.

The “machine No.” column is identification information individually assigned to each image forming apparatus 3 and records, for example, a serial number or the like. The “model CD” column is a model code number of the image forming apparatus 3 (hereinafter, also referred to as a “CD”). Further, for example, among users who use the model, a person who has made a contract with the image forming apparatus 3 (specifically, an administrator on the user side, a representative, a contact person, etc.) corresponds to the “user ID” column of the contract information table 212. The person who has made the contract is an example of a “specific user”.

FIG. 6 is a view illustrating an example of the device parts information table 213. The device parts information table 213 manages the state history of units that constitute a machine. The device parts information table 213 is updated at a predetermined cycle (for example, one hour) according to information indicating the state to be acquired from the image forming apparatus 3.

Specifically, as illustrated in FIG. 6, information is added to the left column every one hour and is moved to the right column as the information becomes older. A number indicating how many hours ago information is recorded in a “history” row. A number “1” indicates the state one hour ago, that is, the latest information among the recorded information. In the example illustrated in FIG. 6, new states are recorded as going to the left, but may be recorded as going to the right. The device parts information table 213 may be formed for each machine or model. The device parts information table 213 is also referred to as a “state management transaction”.

FIG. 7 is a view illustrating an example of the area information table 214. The area information table 214 manages a place where each machine is installed (hereinafter, also referred to as “area information”). As illustrated in FIG. 7, the area information table 214 records detailed information on a place where a machine is installed in association with the “machine No.”. The area information is an example of position information.

FIG. 8 is a view illustrating an example of the machine master 215. The machine master 215 manages units provided for each model. The machine master 215 may be registered in advance at a predetermined timing when manufacturing or selling a model. As illustrated in FIG. 8, the machine master 215 stores information on units, that is, information such as types and functions of the units.

FIG. 9 is a view illustrating an example of the unit exchange determination master 216. The unit exchange determination master 216 stores a level at which an exchange operation may be performed for each unit managed by the machine master 215, that is, each unit registered in the machine master 215 (hereinafter, this level may be referred to as a “work level”). The “work level” is determined according to the attributes of a worker, such as the degree of difficulty of the technique of exchange work, the technical power required to perform the work, a place where the work is performed, and the authority of a person performing the work.

As illustrated in FIG. 9, the unit exchange determination master 216 records, the “work level”, for example, information such as whether a user may exchange a machine, whether a CE (Custom Engineer) (for example, an engineer dispatched to the site from an administrator for repair of a machine) may exchange the machine, and whether a place where the exchange work may be performed is limited to improvement. Here, the term “exchangeable” includes that the exchange work is permitted. The unit exchange determination master 216 may be registered in advance at a predetermined timing when manufacturing or selling a model, similarly to the machine master 215.

FIG. 10 is a view illustrating an example of the machine function master 217. The machine function master 217 manages what units are required to execute each function that each machine has. The machine function master 217 may be registered in advance at a predetermined timing when manufacturing or selling a model, similarly to the machine master 215. “Unit 1” to “unit 16” in a column of a row are associated with the contents recorded as “unit 1” to “unit 16” in the machine master 215 illustrated in FIG. 8. The number of columns is not limited to sixteen (16).

For example, when “device 100” is a multifunction device, information indicating that “unit 1” (specifically, a tray), “unit 2” (specifically, a toner), and “unit 5” (specifically, an HDD) to “unit 14” (specifically, a power supply) are required to execute, for example, the function of “copy” is stored in the machine function master 217.

### (Screen Information 312)

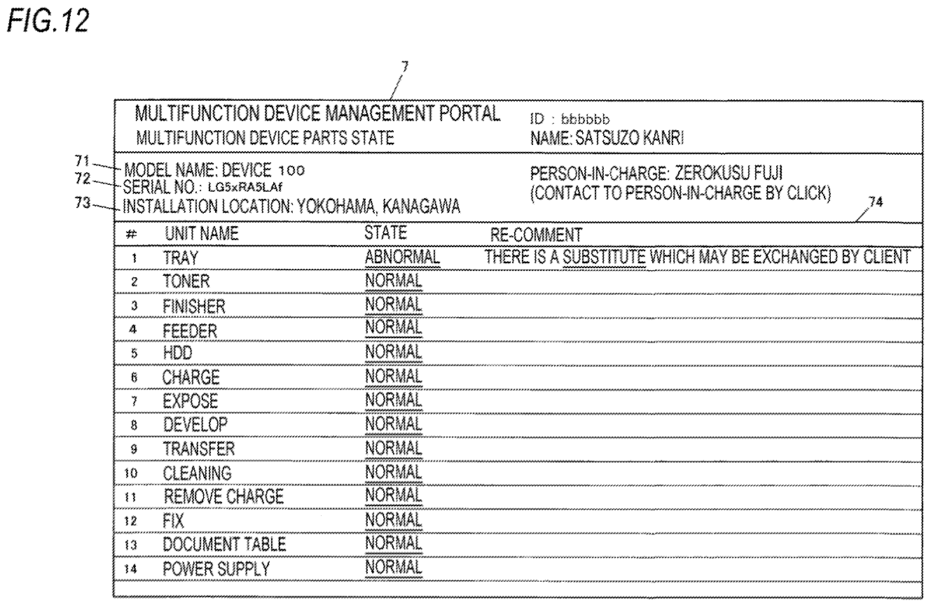

The screen information 312 is information on various screens displayed on a display surface of the operation display unit 32 by the display controller 302. The screen information 312 will be described with reference to FIGS. 12 to 14. FIG. 11 is a view illustrating an example of a multifunction device management portal list screen. The multifunction device management portal list screen 6 is a screen on which information on the image forming apparatus 3 managed by the server apparatus 2 is displayed.

As illustrated in FIG. 11, the multifunction device management portal list screen 6 includes, for example, number information 61 indicating the number of image forming apparatuses 3 managed by the server apparatus 2, abnormal parts information 62 indicating the presence or absence of an abnormal part, area designation information 63 that designates narrowing-down of an area to display only a specific area, model information list 64 listing model information and model state, etc.

FIG. 12 is a view illustrating an example of a multifunction device management parts state screen. The multifunction device management parts state screen 7 is a screen indicating whether a part is normal for each model and recommending a substitute when there is a part that may be substituted. As illustrated in FIG. 12, the multifunction device management parts state screen 7 includes, for example, model name information 71 indicating a model name, serial number information 72 indicating a serial number of a model, installation location information 73 indicating a location where a model is installed, a state list 74 indicating a list of “normal” and “abnormal” for each unit (that is, each part) and indicating a substitute.

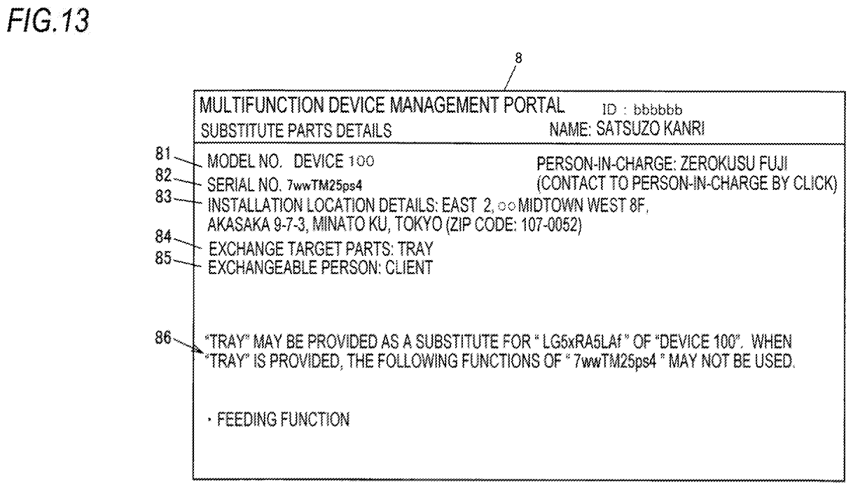

FIG. 13 is a view illustrating an example of a multifunction device management portal substitution parts details list screen. The multifunction device management portal substitution parts details list screen 8 is a screen that displays detailed information on a part to be exchanged when any parts constituting a machine is in an abnormal state. The multifunction device management portal substitution parts details list screen 8 is configured to transition from, for example, a “state” button in the multifunction device management portal list screen 6 described above (see FIG. 11).

As illustrated in FIG. 13, the multifunction device management portal substitution parts details list screen 8 includes, for example, model name information 81, serial number information 82, installation location information 83, an exchange target parts information 84 indicating a part to be exchanged, an exchangeable person information 85 indicating a person who may perform an exchange work, substitution information 86 indicating detailed contents of substitution when a substitute exists, etc. The exchangeable person information 85 acquires and displays the information recorded in the unit exchange determination master 216 described above (see FIG. 9). The substitute is an example of a second unit. A device providing a substitute is an example of the second device.

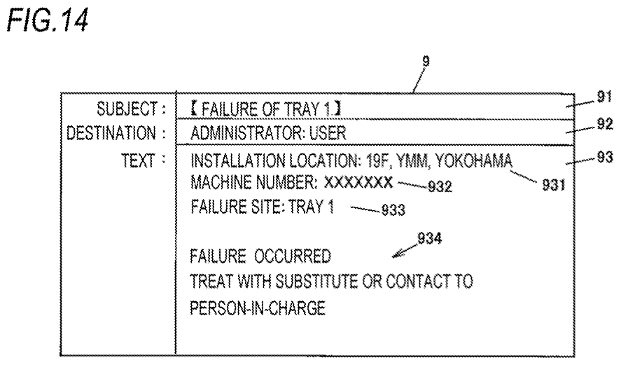

FIG. 14 is a view illustrating an example of an alert e-mail. The alert e-mail 9 is a notification sent to an administrator when the image forming apparatus 3 notifies the server apparatus 2 that a failure has occurred. As illustrated in FIG. 14, the alert e-mail 9 includes, for example, subject information 91, destination information 92 and a text 93. The text 93 describes, for example, installation location information 931 of a failed image forming apparatus, machine number information 932, fault location information 933 indicating a failed location (that is, which unit has failed), contact information 934, and the like.

### [Terminal Apparatus 4]

As the terminal apparatus 4, for example, a portable information terminal such as a personal computer, a tablet terminal or a multifunctional mobile phone (smartphone) may be used.

### (Network 5)

The network 5 may be, for example, a local area network (LAN), a wide area network (WAN), the Internet, an intranet or the like, and may be wired or wireless.

### [Operation of Exemplary Embodiment]

Next, an example of the operation of the image forming system 1 will be described. The operation of the image forming system 1 includes (1) an operation of checking the state of a unit, (2) an operation of receiving a notification of a failed unit, and (3) an operation related to exchange of a failed unit. The details of these operations will be described below.

### (1) Operation of Checking the State of a Unit

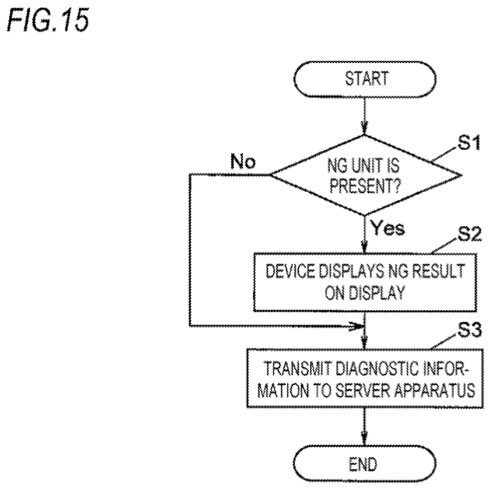

FIG. 15 is a flowchart illustrating an example of the operation of the image forming apparatus 3. As illustrated in FIG. 15, the display controller 302 refers to the diagnostic information 311 of the storage unit 31. When there is a unit in which a certain failure has occurred (hereinafter, which may be referred to as an “NG unit” or a “failed unit”) in the image forming apparatus 3 (“Yes” in S1), the display controller 302 performs a control so that a display of the operation display unit 32 displays a result indicating that there is an NG unit (hereinafter, which may be referred to as an “NG result”) (S2). The image forming apparatus 3 may be simply referred to as a “device”. In addition, the transmitting unit 300 transmits the diagnostic information 311 to the server apparatus 2 (S3).

### (2) Operation of Receiving a Notification of a Failed Unit

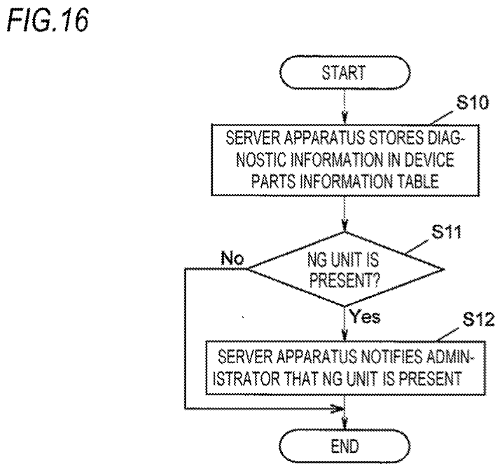

FIG. 16 is a flowchart illustrating an example of the operation of the server apparatus 2. As illustrated in FIG. 16, the server apparatus 2 receives the diagnostic information 311 and stores the diagnostic information 311 in the device parts information table 213 (see FIG. 6) (S10).

The server apparatus 2 refers to the device parts information table 213 to check whether there is an NG unit (S11). When there is an NG unit (“Yes” in S11), the server apparatus 2 notifies the administrator that there is an NG unit (S12).

### (3) Operation Related to Exchange of a Failed Unit

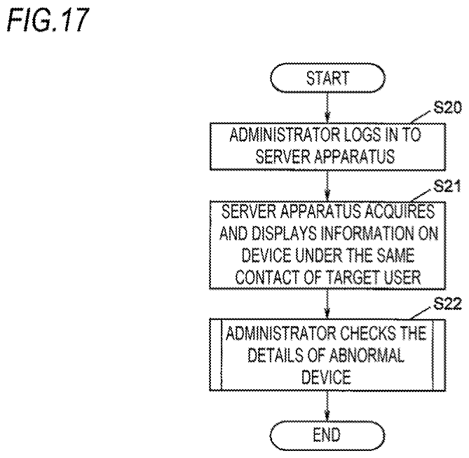

Hereinafter, an example of an operation related to exchange of a failed unit will be described. FIG. 17 is a flowchart illustrating an example of an administrator's operation; and As illustrated in FIG. 17, the administrator logs in to the server apparatus 2 (S20). The server apparatus 2 collates with the user management table 211 to authenticate the administrator who is about to log in.

The server apparatus 2 acquires and displays information on devices under the same contract of a target user (S21). The phrase “under the same contract” means that things are within contract made by the target user. For example, the phrase “under the same contract” refers to devices for which the same user is recorded in the contract information table 212.

Specifically, the server apparatus 2 refers to the contract information table 212 to acquire the diagnostic information 311 for models for which the same ID is recorded in the “user ID” column, and displays, on a display of the administrator terminal 4B, the multifunction device management portal list screen 6 on which the corresponding information is displayed, as illustrated in FIG. 11.

The administrator refers to this display to check the details of the device including the NG unit (hereinafter, also referred to as an “abnormal device”) (S22). This check may be simply referred to as a “detailed check”.

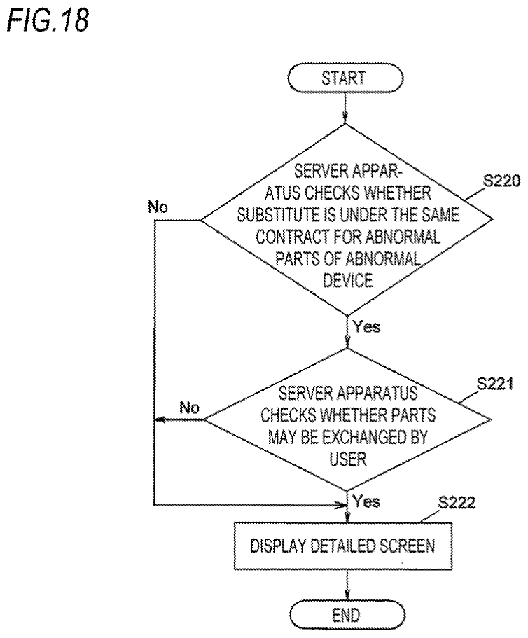

FIG. 18 is a flowchart illustrating an example of the details check operation illustrated in FIG. 17. The server apparatus 2 refers to the information on the machine master 215 and the like to check whether a substitute is under the same contract for an abnormal part of an abnormal device (S220).

Specifically, the acquisition unit 200 acquires information on a location where an abnormality of a target model has occurred (hereinafter, simply referred to as an “abnormal location”), from the device parts information table 213. In addition, the acquisition unit 200 acquires information on the target model from the contract information table 212. Further, the acquisition unit 200 acquires information on a model whose abnormal location may be exchanged, from the machine master 215.

When a substitute is under the same contract for the abnormal part (“Yes” in S220), the server apparatus 2 refers to the unit exchange determination master 216 to check whether the abnormal location is a part which may be exchanged by the user (S221).

Specifically, the determination unit 201 refers to the unit exchange determination master 216 to determine whether the abnormal location may be exchanged by the user's work. When the abnormal location may be exchanged by the user's work, the server apparatus 2 may refer to the area information table 214 to recommend and display a place where a substitute is installed.

When the abnormal location is a part that may be exchanged by the user (“Yes” in S221), as illustrated in FIG. 12, the detailed screen of the multifunction device management parts state screen 7 or the like is displayed (S222).

The exemplary embodiments of the present disclosure have been described above. It should be noted that the present disclosure is not limited to the exemplary embodiments. The exemplary embodiments may be modified and practiced in different ways without departing from the gist of the present disclosure. For example, the screen displayed on the display of the operation display unit 32 may be displayed on the display of the terminal apparatus 4, and the screen displayed on the display of the terminal apparatus 4 may be displayed on the display of the operation display unit 32.

Further, for example, a part of the units provided in the controller 20 of the server apparatus 2 may be moved to the controller 30 of the image forming apparatus 3. Further, a part of the units provided in the controller 30 of the image forming apparatus 3 may be moved to the controller 20 of the server apparatus 2. Various data stored in the storage unit 21 of the server apparatus 2 may be stored in the storage unit 31 of the image forming apparatus 3, and various data stored in the storage unit 31 of the image forming apparatus 3 may be stored in the storage unit 21 of the server 2.

Each of the units of the controller 20 and 30 is partially or entirely implemented by a hardware circuit such as a reconfigurable circuit (FPGA: Field Programmable Gate Array) or an application specific integrated circuit (ASIC).

Further, a part of the elements of the exemplary embodiments may be omitted or changed without departing from the gist of the present disclosure. Further, steps may be added, deleted, changed, replaced, and the like in the flow of the above-described exemplary embodiments without departing from the gist of the present disclosure. Further, the program used in the above-described exemplary embodiments may be provided in the form of a computer-readable recording medium such as a CD-ROM, or may be stored in an external server such as a cloud server and used via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing system comprising:
a processor programmed to:
determine when an abnormality occurs in a first component of a first device connected to a management apparatus, and
specify a second component that is exchangeable with the first component and compatible with the first device, in a second device connected to the management apparatus; and
a display controller configured to display information on the specified second component and the second device.

2. The information processing system according to claim 1, wherein the processor is programmed to specify the second component according to an attribute of a worker who is permitted in advance to exchange the first component with the second component.

3. The information processing system according to claim 1, wherein the processor is programmed to specify the second device among devices managed by a specific user who manages the first device.

4. The information processing system according to claim 1, wherein the display controller performs a control to further display position information indicating a place where the second device is installed.

5. The information processing system according to claim 4, wherein the display controller performs a control to display a device installed in a specific area narrowed-down in advance among the specified second devices.

6. An information processing apparatus comprising:
a processor programmed to acquire diagnostic information including information indicating that an abnormality has occurred in a first component of the information processing apparatus, and transmit the diagnostic information to a management apparatus; and
a display controller configured to, when the abnormality occurs in the first component, display a second component that is exchangeable with the first component, compatible with the information processing apparatus, and specified in a second device other than the information processing apparatus, the second device being connected to the management apparatus.

7. A non-transitory computer readable medium storing a program that causes a computer to execute information processing, the information processing comprising:
determining that an abnormality occurs in a first component of a first device connected to a management apparatus,
specifying a second component that is exchangeable with the first component and compatible with the first device, in a second device connected to the management apparatus; and
displaying information on the specified second component and the second device.
